(19) United States
(12) Patent Application Publication
(10) Pub. No.: US 2025/0260989 A1
(43) Pub. Date: Aug. 14, 2025

(54) SYSTEMS AND METHODS FOR DETECTING ROGUE BASE STATIONS

(71) Applicant: T-MOBILE USA, INC., Bellevue, WA (US)

(72) Inventors: Geoffrey Gibson, Rowlett, TX (US); Marouane Balmakhtar, Fairfax, VA (US); Gregory Schumacher, Holliston, MA (US)

(21) Appl. No.: 18/441,351

(22) Filed: Feb. 14, 2024

(51) Int. Cl. H04W 12/122

(52) U.S. Cl. CPC H04W 12/122

(57) ABSTRACT

Systems and method for detecting a presence of rogue base stations are provided. The systems and methods may include obtain RF signal scan data indicative of RF conditions associated with a plurality of cells supported by operator-controlled base stations. The RF signal scan data may then be input a machine learning model to detect the presence of the rogue base station. The machine learning model may include one or more of an anomaly detection model, a classification model, a time series analysis model, and an ensemble model. In response to detecting the presence of the rogue base station, the systems and methods may generate an alert.

### BACKGROUND

Network operators provide network services to user equipment (UEs) located within a service region associated with a coverage area provided by a plurality of base stations. UEs configured to access the network operator's network will attempt to connect and utilize the network service when location within the service region. Knowing this, hackers have developed fake base stations that spoof the appearance of a base station to nearby UEs (referred to herein as “rogue base stations”). The rogue base station may then forward communications to operator-controlled base stations such that the UE does not know it is connected to a rogue base station. As a result, the UEs may automatically connect to the rogue base station, potentially exposing UE data to the hacker, without alerting a user of the UE. Moreover, because the rogue base station radiates power in a manner similar to a base station, the rogue base stations also interfere with operator-controlled base stations, degrading the performance of the network service provided thereby.

In view of the foregoing challenges, there is a need for systems and methods of detecting rogue base stations.

### SUMMARY

In one embodiment, the techniques described herein relate to a computer-implemented method for detecting rogue base stations including: (1) obtaining, by one or more processors, radio frequency (RF) signal scan data indicative of RF conditions in a cell of an operator base station; (2) inputting, by the one or more processors, the RF signal scan data into a machine learning model trained at least in part using historical RF signal scan data indicative of base station operation in an absence of a rogue base station; (3) detecting, by the one or more processors, an output of the machine learning model indicative of a presence of a rogue base station; and (4) generating, by the one or more processors, an alert indicative of the presence of the rogue base station.

In another embodiment, the techniques described herein relate to a system for detecting rogue base stations including: (i) one or more transceivers communicatively coupled to an operator base station; (ii) one or more processors; and (iii) one or more non-transitory memories storing processor-executable instructions that, when executed by the one or more processors, cause the system to: (1) obtain radio frequency (RF) signal scan data indicative of RF conditions in a cell of an operator base station; (2) input the RF signal scan data into a machine learning model trained at least in part using historical RF signal scan data indicative of base station operation in an absence of a rogue base station; (3) detect an output of the machine learning model indicative of a presence of a rogue base station; and (4) generate an alert indicative of the presence of the rogue base station.

In yet another embodiment, the techniques described herein relate to a non-transitory storage medium storing computer-executable instructions that, when executed by one or more processors, cause the one or more processors to: (1) obtain radio frequency (RF) signal scan data indicative of RF conditions in a cell of an operator base station; (2) input the RF signal scan data into a machine learning model trained at least in part using historical RF signal scan data indicative of base station operation in an absence of a rogue base station; (3) detect an output of the machine learning model indicative of a presence of a rogue base station; and (4) generate an alert indicative of the presence of the rogue base station.

### BRIEF DESCRIPTION OF THE DRAWINGS

FIG. 1 depicts an example environment in which the rogue base station detection techniques described herein are implemented.

FIG. 2 depicts an example model structure for a machine learning model that may be implemented by the analysis server of FIG. 1.

FIG. 3 depicts a diagram of an analysis server.

FIG. 4 depicts an example method for detecting rogue base stations.

### DETAILED DESCRIPTION

Embodiments described herein relate to techniques for detecting a rogue base station. It should be appreciated that there is generally no defined correlation between the various base station metrics monitored by a network operator and the behavior of a rogue base station. That is, when a rogue base station is present in a particular cell or sector of coverage, there is no conventional metric for the network operator to monitor that can reliably indicate that a rogue base station is impacting operation of an operator-controlled base stations and/or a cell or sector thereof. Accordingly, techniques described herein relate to collecting a plurality of signal scan data to train a machine learning model capable of analysis a plurality of different metrics to detect the presence of a rogue base station. When a rogue base station is detected, techniques disclosed herein further relate to identifying a location in the service region at which the rogue base station is likely to be located.

As it is used herein, the term “signal scan data” may refer to any type of data that may be captured by an operator-controlled base station. For example, the signal scan data may include reports (e.g., measurement reports, neighboring cell reports, etc.), protocol messaging (e.g., registration request message, error messages, and/or other protocol-defined messages), and/or other data transmitted over the communication network by the serviced UEs and/or neighboring cells. As another example, the signal scan data may include power and/or signal quality measurements performed by one or more transceiver unit of the base station. As another example, the operator-controlled base station and/or the analysis server may extract frequency-domain data (such as bit error rate, block error rate, the power levels at particular carrier frequencies, out-of-band power levels, subcarrier spacing, channel allocation data, and/or other data derived from a frequency-domain analysis of the sensed signals) to derive one or more additional metrics and/or data steams included in the signal scan data.

It should be appreciated that different types of rogue base stations may exhibit different characteristics. For example, some rogue base stations may attempt to cause all UEs in a region to connect thereto. Accordingly, these rogue base stations may operate at a relatively high power to increase the radius in which devices will connect to the rogue base station. As another example, some rogue base stations may be configured to cause a target UE at a known location to connect thereto (these are sometimes called sting ray devices). Accordingly, these devices may operate at relatively low power to minimize the number of non-target UEs connected thereto. Techniques described herein may be applied to detect anomalous conditions caused by either type of rogue base station.

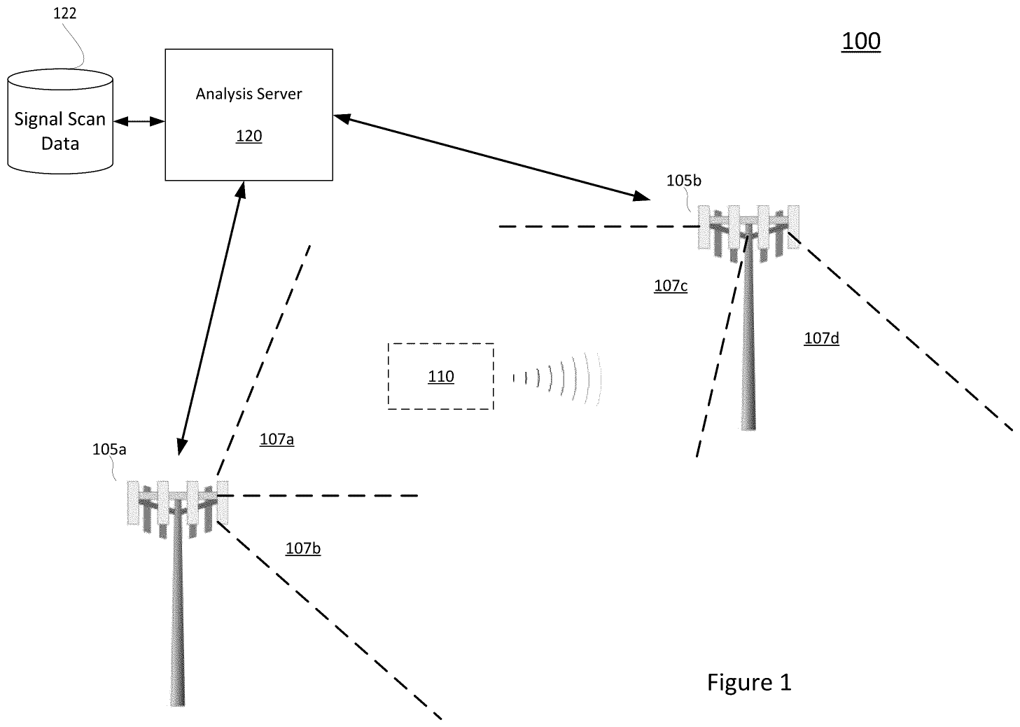

FIG. 1 depicts an example environment 100 in which the rogue base station detection techniques described herein are implemented. As illustrated, the environment 100 includes a plurality of cell sites 105 (e.g., 105a and 105b) that includes one or more nodes via which a network operator provides network services to user equipment (UEs). As it is generally used herein, the term “base station” may refer to a node of a cell site 105. The nodes may be configured in accordance with a communication protocol supported by the node. For example, the cell sites 105 may include an evolved node B (eNB), a next generation node B (gNB), an EVDO node, a CDMA node, a GPRS node, a Wi-Max node, etc.

Reference may be made herein to particular components and/or messaging associated with a particular communication protocol. However, this is done for ease of explanation, and it is envisioned that the techniques described herein may be applied to communication networks that support any communication protocol. Accordingly, any reference to a particular component or message envisions equivalent and/or similar structures associated with other communication protocols.

As illustrated the nodes of the cell sits 105 may divide the service area supported by the cell sites 105 into cells 107 (e.g., 107a, 107b, 107c, and 107d). In some network configurations, the cells 107 may also be referred to as sectors. Each cell 107 of the node may support a control plane and user plane for communications with UEs within the coverage area of the cell 107.

To generate signal scan data, the nodes of the cell sites 105 may measure traffic patterns associated with communications to and from the UEs. In some embodiments, the measured traffic patterns include measuring characteristics of the radio bearers the support the traffic. For example, the nodes may measure the radio bearers at the packet data convergence protocol (PDCP) level to measure, for example, resource block data, resource allocation type, modulation and coding scheme, code rate, transport block data, buffer sizes, etc. Accordingly, the nodes may compile the traffic pattern data into the signal scan data.

As another example, the nodes of the cell sites 105 may apply a transform (such as a Fourier Transform) to the received signals to determine one or more frequency-domain characteristics. For example, because rogue base stations may operate without coordination with the operator-controller base stations, the communications to and from the rogue base station may manifest as causing increased error rates (such a bit error rate or block error rate) or an increased amount of power at out-of-band frequencies. Accordingly, the nodes may extract metrics indicative of bit error rate, block error rate, power levels at carrier frequencies, out-of-band power levels, subcarrier spacing, channel allocation data, etc. to include in the signal scan data.

As another example, the node of the cell sites 105 may measure physical characteristics of the signals transmitted and received form the antennas of the nodes. For example, the nodes may record a signal to noise ratio (SINR), a carrier to noise ratio (CNR), a received total wideband power (RTWP), a receive power, etc. As described above, a rogue base station tends to cause interference. Accordingly, this interference may manifest as an increase to the noise floor levels (which is typically measured using RTWP). Similarly, the interference may cause a lower SINR and/or cause the receive power of an antenna to be too strong. Accordingly, the nodes may compile the set of physical characteristics into a portion of the signal scan data.

As another source of signal scan data, UEs may periodically measure one or more signal characteristics associated with the signals received from the nodes of the cell sites 105 and transmit the measured signal characteristics in a measurement report. For example, the measurement reports may include a reference signal receive power (RSRP), a reference signal received quality (RSRQ), and/or a reference signal SINR (RS-SINR) for signals exchanged between the serving cell 107 and/or one or more neighbor cells 107. Thus, the measurement report may include the serving cell identifier, the neighbor cell identifiers, and the corresponding RF measurement data. While the measurement report may include information regarding a plurality of cells 107, the UE may transmit the measurement report to the node currently serving the UE.

Similarly, as part of network operations, neighboring cells may exchange neighboring cell RF information reports with one another. The neighboring cell RF information reports may include a list of nearby cell IDs and measurement data (such as RSRP, RSRQ, RS-SINR) associated therewith. Accordingly, the serving nodes may analyze the traffic to detect UE measurement reports and/or neighboring cell RF information reports and extract relevant data for inclusion in the signal scan data.

It should be appreciated that in some systems, measuring and compiling the signal scan data may impact downlink performance of the node. Accordingly, in some embodiments, the nodes may generate the signal scan data in periods of low activity. For example, the nodes may be configured to generate the signal scan data at times of day associated with low activity (e.g., overnight), when a threshold amount of the supported traffic has low quality of service (QoS) requirements, or when there are a threshold amount of available resources. As a result, these systems are able to implement the disclosed rogue base station detection techniques while minimizing the impact on the service provided to the UEs.

The cell sites 105 may be connected to a core network (not depicted) of a communication network operated by a network operator. Accordingly, the cell sites 105 are configured to transmit data from the core network to UEs within the service and receive data from the served UEs for routing over the core network. The core network 115 may be an evolved packet core (EPC) or type of core network defined by a communication protocol. Similarly, the cell sites 105 are configured to transmit the compiled signal scan data over the core network to an analysis server 120.

The analysis server 120 may be configured to implement one or more machine learning techniques to detect the presence of a rogue base station within the environment 100. More particularly, the analysis server 120 may be configured to receive the signal scan data from a plurality of cell sites 105 (and/or nodes thereof) to detect the presence of a rogue base station using a machine learning model.

Additionally, upon receiving the signal scan data, the analysis server 120 may store the signal scan data in a database 122. In some embodiments, the database 122 is organized such that each cell site 105 and/or cell ID associated with cell 107 is associated with a record. In these embodiments, the analysis server 120 may store the obtained signal scan data in the record corresponding to the cell 107 associated with received the signal scan data. The analysis server 120 may associate the collections of signal scan data with time stamps indicative of when the signal scan data was collected (e.g., a collection start time, a collection end time, a time at which the collection was received at the analysis server 120, etc.).

In some embodiments, the database 122 of signal scan data is used to train and/or refine the machine learning models disclosed herein. For example, baseline and/or normal operating conditions with a given cell 107 may change over time. Accordingly, the analysis server 120 may use a rolling window of data (e.g., the prior week, the prior month, the prior three months, etc.) when establishing a baseline model of normal operating conditions. As a result, the machine learning models described herein may be localized to the particular operating environment of the cell sites 105.

Additionally, in some embodiments, when the analysis server 120 determines that a rogue base station is present in a cell 107, the analysis server 120 may obtain from the database 122 signal scan data associated with one or more neighboring cells. In the illustrated example, the analysis server 120 may determine that a rogue base station 110 is located in cell 107a of the cell site 105a based on an output of the machine learning model. In response, the analysis server 120 may verify the detection of the rogue base station 110 by obtaining data stored in the database 122 associated with neighboring cell 107b of the cell site 105a and the neighboring cell 107c of the cell site 105b. If no data is available in the database 122, the analysis server 120 may initiate the collection of a set of signal scan data at the neighboring cell 107c. If the impacts of the rogue base station 110 are detected in the signal scans associated with cells 107c and/or 107b, then the analysis server 120 may have higher confidence the rogue base station 110 is in fact located proximate to the cell 107a. It should be appreciated that if the cell site 105a includes nodes with overlapping coverage areas that implement different communication protocols at different frequencies, the analysis server 120 may also verify the presence of the rogue base station 110 by analyzing the other nodes of the cell site 105a in a similar manner. After verifying the presence of the rogue base station 110, the analysis server 120 may generate an alert to the network operator. For example, the alert may be transmitted to a network operation center and/or a service technician and include an indication of the cell 107 and/or cell site 105 at which the impacts of the rogue base station 110 was detected.

In some embodiments, if the presence of the rogue base station 110 is detected across multiple cells 107 of the cell sites 105, the analysis server 120 may analyze the coverage area of each of the cells 107 to determine a region in which the rogue base station 110 is likely to be located. To this end, network operators typically maintain a map of each cell sit 105 and the orientation of cell 107 thereof. Accordingly, if the analysis server 120 detects impacts of the rogue base station 110 in the signal scan data associated with cells 107a and 107c, but not 107b and 107d, the analysis server 120 may obtain location data from the map associated with cells 107a and 107c to define a geographic region in which the rogue base station 110 is likely to be located. In one example, the geographic region may be defined with respect to a boundary between the cells 107a and 107c. Accordingly, in these embodiments, the alert may cause a map to display on a network operator device that indicates a location to investigate for the presence of the rogue base station 110.

Additionally, in some embodiments, the signal scan data received from the cell sites 105 may indicate a serving cell ID not included in a pool of cell IDs associated with operator-managed base stations. If the cells 107 impacted by the presence of rogue base station include neighbor cell reports that indicate serving cell IDs unknown to the network operator, it is likely that the unknown serving cell ID is associated with the rogue base station 110. In these embodiments, the UEs may include a blacklist of serving cell IDs to which the UE should avoid attaching. For example, the blacklist may be maintained in an application distributed by the network operator to facilitate connectivity with their network services. Accordingly, in response to detecting the unknown serving cell ID, the analysis server 120 may push an update to the blacklist to the UEs in the region of cell sites 105 to prevent the UEs from attaching to the rogue base station 110.

As another example, in some embodiments, nodes polled for a UE measurement report and/or a neighboring cell RF information report may be configured to reply with a geographic location (e.g., a global positioning system (GPS) location). As described above, network operators typically maintain a map indicating the location of the cell sites 105. Accordingly, if a rogue base station is configured to spoof a cell ID of an operator-controlled base station, the geographic location data will not match the location for the cell ID maintained in the map. Thus, a mismatch between an expected geographic location of a cell ID and the location of cell ID included in a UE measurement report and/or a neighboring cell RF information report may indicate the presence of the rogue base station 110.

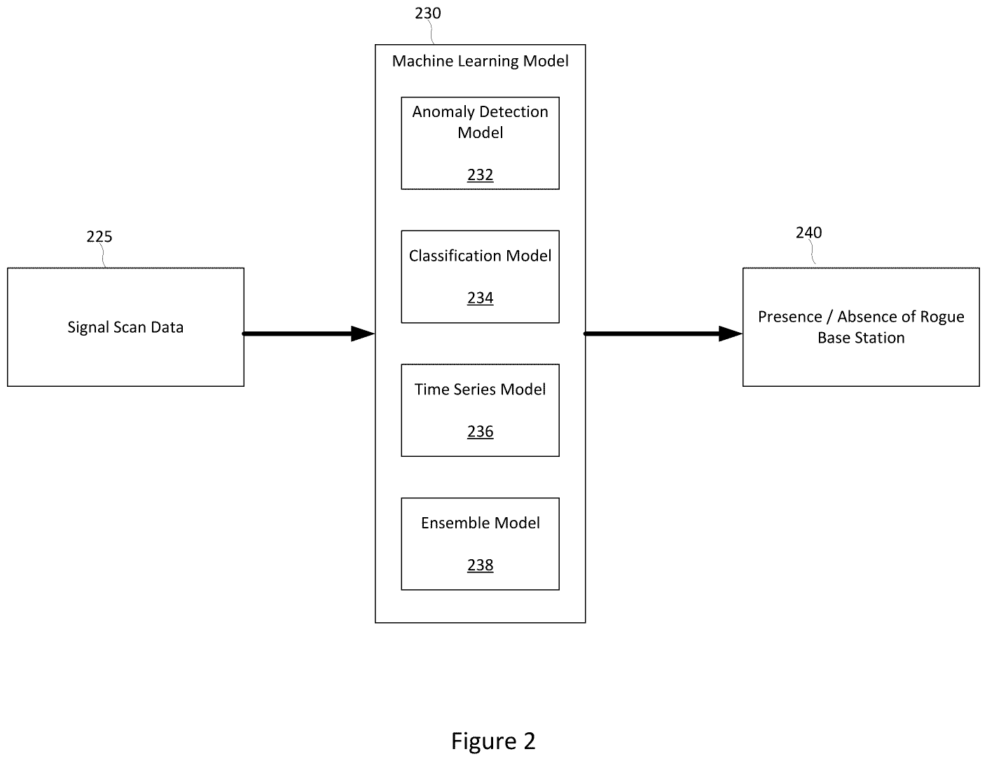

Turning to FIG. 2, illustrated is an example model structure for a machine learning model 230 that may be implemented by the analysis server 120 to detect the presence of the rogue base station 110. Generally, the analysis server 120 may obtain signal scan data 225 associated with a cell 107 and input the signal scan data 225 into the machine learning model 230. In response, the machine learning model 230 outputs a indication 240 of whether or not the signal scan data 225 is indicative of a presence of a rogue base station.

As illustrated, the machine learning model 230 may include one or more component models 232-238 that implement different machine learning techniques to detect the presence of the rogue base station 110. Accordingly, each of the models 232-238 may act upon different data streams included in the signal scan data 225. It should be appreciated that if the machine learning model 230 does not include a component model 232-238 that acts upon a particular data stream described herein, that data stream may be omitted from the signal scan data 225 when compiled at the node of the cell site 105.

Starting with the anomaly detection model 232, the anomaly detection model 232 may be configured to detect deviations in normal operation in one or more performance metrics. For example, the anomaly may be detected in the reference signal receive power (RSRP), reference signal receive quality (RSRQ), or reference signal signal-to-noise ratio (RS-SINR) data included in the measurement reports detected at the cell 107.

In some embodiments, the anomaly detection model 232 is a one-class support vector machine (SVM) model. Unlike a typical multi-class SVM model, the one-class SVM model does not rely on labeled classifications to train. Instead, the one-class SVM model is trained using a set of normal operating condition data to learn boundary that defines normal operation. For example, the one-class SVM model may be trained using historical data from the database 122 (or elsewhere) associated with cells 107 known to not be impacted by the presence of a rogue base station. Accordingly, the model data for the anomaly detection model 232 may include the definition of the boundary region in a feature space defined by input parameters to the anomaly detection model 232 (e.g., RSRP, RSRQ, RS-SINR, and so on). If the input signal scan data 225 maps to a point in the feature space outside of the boundary that defines normal operation, the anomaly detection model 232 may output an indication 240 indicative of the presence of a rogue base station.

It should be appreciated alternate anomaly detections may be implemented by the model 232. For example, the anomaly detection model 232 may implement unsupervised learning techniques to train an isolation forest model or an autoencoder model to detect anomalous inputs from the signal scan data 225.

Turning to the classification model 234, the classification model 234 may be trained to classify the signal scan data 225 as belonging to a normal base station or a rogue base station. For example, the classification model 234 may be a multi-class SVM model trained using labeled signal scan data from normal base stations and rogue base stations.

One example way that rogue base stations may operate differently is that rogue base stations may not exchange neighboring cell RF information reports with neighboring cells and/or report data inconsistent with records maintained by the network operator. Another example way the presence of a rogue base station may manifest is an increase in noise floor levels and/or an increase in failures (such as random-access channel (RACH) failures). Yet another way the presence of a rogue base station may manifest is through suboptimal usage of the available subcarriers (or other RF bearers) or the presence of errors in the modulated signal. Accordingly, the training signal scan data for the classifiers may include measure RTWP values, RSSI values, protocol messaging, carrier frequency data, bit error rate data, block error rate data, subcarrier spacing data, out-of-band power data, and/or other data indicative of the increased interference caused by the presence of a rogue base station.

It should be appreciated that the in some embodiments, the classification model 234 includes multiple trained classifiers. For example, one classifier may be trained using labeled historical signal scan data indicative of normal operation of a base station in the absence of a rogue base station and labeled historical signal scan data indicative of operation of a base station in the presence of a rogue base station. Accordingly, this classifier may identify whether a rogue base station is operating proximate to the operator-controlled base station. As another example, a classifier may be trained using labeled historical signal scan data from an operator-controlled base station and labeled historical signal scan data from a rogue base station. Accordingly, this classifier may identify whether the obtained signal scan data is from an operator-controlled base station or a rogue base station. If a classifier is trained to detect a mismatch between reported cell information and operator-maintained cell information, the classification model 234 may also accept one or more operator records as an input to provide the ground truth used during the classification process.

In an SVM training process, training the classifiers may involve defining a hyperplane separating the feature space into a region associated with normal operation of a base station and a region associated with a rogue base station. Accordingly, the model data for the SVM classifier may include a definition of the hyperplane in the model feature space. In some embodiments, gradient boosting techniques are implemented in the training process. In other embodiments, other types of classifiers may be trained using similar training data. For example, a random forest classification may be implemented in the classification model 234. Regardless of the particular structure of the classification model 234, the output 240 of the classification model 234 may be a first label indicative of a normal operation of a base station or a second label indicative of operation of a rogue base station.

Turning to the time series model 236, the time series model 236 may be configured to anomalous signal scan data based on changes in the signal scan data over time. For example, the signal scan data may include the set of metric captured during a predetermined time interval (e.g., one minute, five minutes, fifteen minutes, thirty minutes, and hour, etc.).

In some embodiments, the time series model 236 may be trained to identify sequences of signal scan data (e.g., RACH failures, RSSI, RTWP, RSRP, RSRQ, RS-SINR, etc.) that are unlikely to have occurred during normal operation. Accordingly, the time series model may include a recurrent neural network (RNN), such as a Long Short-Term Memory (LSTM) network that is configured to determine temporal dependencies using sets of historical signal scan data as training data. Accordingly, as the signal scan data 225 is input to the time series model 236, the time series model 236 may predict future values in the time series based on the learned dependencies under normal operations. If the prediction is incorrect by a threshold amount (e.g., a standard deviation, two standard deviations), the time series model 236 may generate an output 240 indicative of the anomalous condition.

In other embodiments, the time series model 236 may be an auto-regressive integrated moving average (ARIMA) model or a seasonal auto-regressive integrated moving average (SARIMA) model trained to identify temporal patterns in the input signal scan data. An ARIMA or SARIMA model may be able to detect patterns in signal scan data 225 that indicate that an anomaly is about to occur. Accordingly, the training data for the ARIMA or SARIMA models may include historical training data in which a rogue base station first begins to interfere with normal operation of a base station. Thus, if the ARIMA or SARIMA model predicts that an anomaly is likely to occur, and the signal scan data 225 matches that prediction, the ARIMA or SARIMA model may generate an output 240 indicating that the presence of a rogue base station.

Turning to the ensemble model 238, the ensemble model 238 may be configured to coordinate between two or more anomaly detection models 232, classification models 234, or time series models 236 to generate the output 240. For example, the ensemble model 238 may coordinate inputting the appropriate data stream in the signal scan data 225 to the corresponding model 232-236. The ensemble model 238 may then detect and analyze the respective outputs to reach a final decision. To this end, the ensemble model 238 may implement a consensus or voting mechanism in which the outputs from the models 232-236 are combined to produce the output 240. For example, the ensemble model 238 may only provide an output 240 indicative of a presence of a rogue base station if agreed upon by a majority of the component models 232-236. In other examples, other classification consensus mechanisms may be implemented.

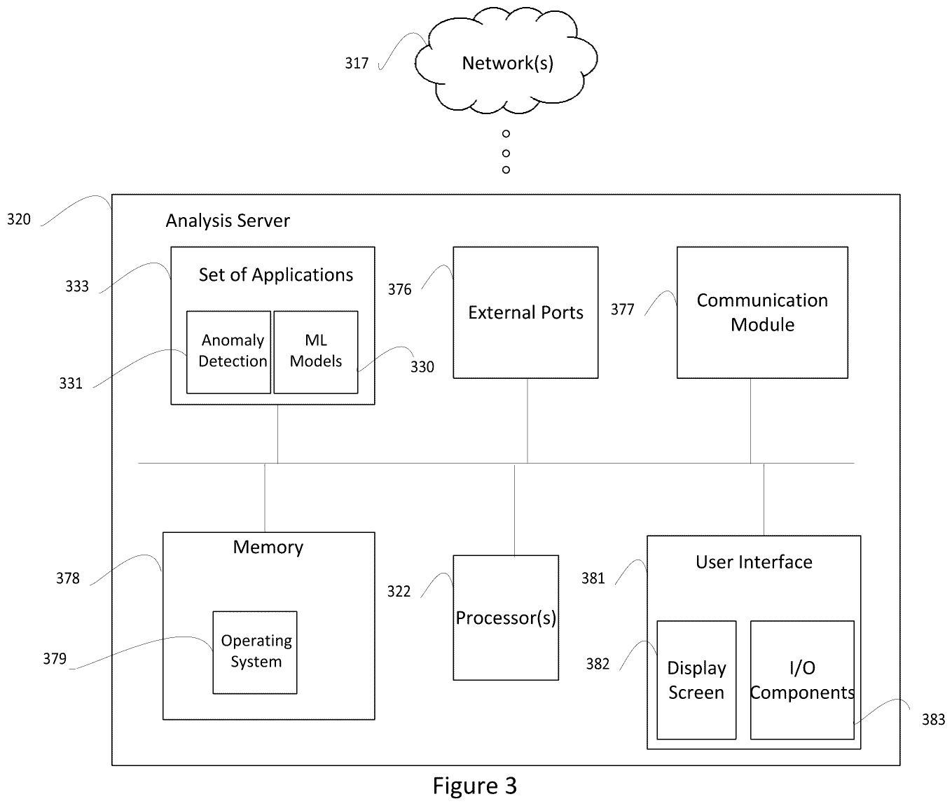

FIG. 3 illustrates a diagram of an analysis server 320 (such as the analysis server 120 as discussed with respect to FIG. 1) in which the functionalities as discussed herein may be implemented.

The analysis server 320 may include one or more processors 322 as well as a memory 378. The memory 378 may store an operating system 379 capable of facilitating the functionalities as described herein. The analysis server 320 may also store a set of applications 333 (i.e., machine readable instructions). For example, one of the set of applications 333 may be an anomaly detection application 331 configured to coordinate the collection of signal scan data (such as the signal scan data 225 of FIG. 2) from cell sites (such as the cell sites 105 of FIG. 1), the analysis of the signal scan data by machine learning models 330 (such as the machine learning model 230 of FIG. 2), and processing of the outputs (such as the outputs 240 of FIG. 2) of the machine learning models 330. Additionally, the machine learning models 330 may be a an application 333 that is called via an application programming interface (API) by the anomaly detection application 331. It should be appreciated that other applications are also envisioned.

The one or more processors 322 may interface with the memory 378 to execute the operating system 379 and the set of applications 333. The memory 378 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

The analysis server 325 may further include a communication module 377 configured to communicate data via one or more networks 317. According to some embodiments, the communication module 377 can include one or more transceivers (e.g., WWAN, WLAN, and/or WPAN transceivers or ethernet, optical, or other backhaul transceivers) functioning in accordance with IEEE standards, 3GPP standards, or other standards, and configured to receive and transmit data via one or more external ports 376. For example, the communication module 377 may receive, via a core network of the network operator, the signal scan data from a plurality of cell site. As another example, the communication module 377 may transmit alerts to UEs or network operation personal via one or more communication networks, include the communication networks supported by the cell sites of the network operator.

The analysis server 320 may further include a user interface 381 configured to present information to the user and/or receive inputs from the user. As shown in FIG. 3, the user interface 381 may include a display screen 382 and/or I/O components 383 (e.g., ports, capacitive or resistive touch sensitive input panels, keys, buttons, lights, LEDs, speakers, microphones). According to the present embodiments, the user may access the analysis server 320 via the user interface 381 to update the operating system 379 and/or perform other functions. In some embodiments, the analysis server 320 may perform the functionalities as discussed herein as part of a “cloud” network or can otherwise communicate with other hardware or software components within the cloud to send, retrieve, or otherwise analyze data.

In general, a computer program product in accordance with an embodiment may include a computer usable storage medium (e.g., standard random access memory (RAM), an optical disc, a universal serial bus (USB) drive, or the like) having computer-readable program code embodied therein, wherein the computer-readable program code is adapted to be executed by the one or more processors 322 (e.g., working in connection with the operating system 379) to facilitate the functions as described herein. In this regard, the program code may be implemented in any desired language, and may be implemented as machine code, assembly code, byte code, interpretable source code or the like (e.g., via Python, or other languages, such as C, C++, Java, Actionscript, Objective-C, Javascript, CSS, XML). In some embodiments, the computer program product may be part of a cloud network of resources.

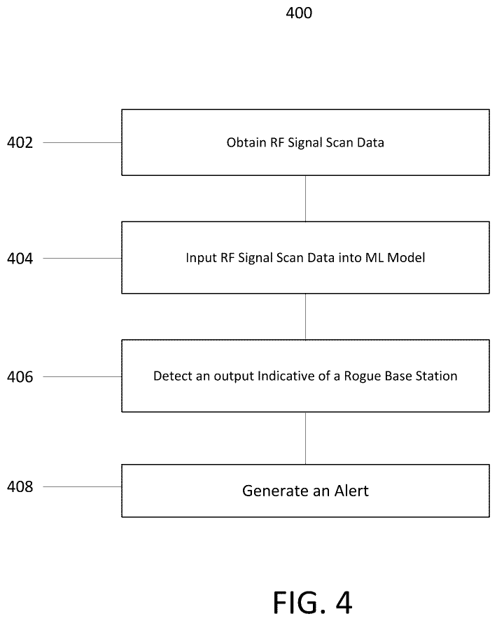

Turning to FIG. 4, illustrated is an example method 400 for detecting rogue base stations. The method 400 may be performed by one or more processors (such as the processors 322 of FIG. 3) of an analysis server (such as the analysis servers 120, 320). The analysis server may be communicative coupled to a plurality of cell sites (such as the cell sites 105 of FIG. 1) via a core network.

The method 400 may begin at block 402 when the analysis server obtains radio frequency (RF) signal scan data (such as the signal scan data 225 of FIG. 2) indicative of RF conditions in a cell (such as the cells 107 of FIG. 1) of an operator base station (such as a node at the cell sites 105). In some embodiments, the RF signal scan data includes indications of random access channel (RACH) failures, standalone dedicated control channel (SDDCH) failures, signal to noise ratio (SINR) values, received signal strength indicator (RSSI) values, or received total wideband power (RTWP) values generated by the operator base station. Additionally or alternatively, the RF signal scan data may include indications of reference signal receive power (RSRP), reference signal received quality (RSRQ), reference signal SINR (RS-SINR), serving cell RF information, neighbor cell RF information, cell ID, or serving cell ID generated by (i) user equipment (UE) served by the operator base station or (ii) a neighboring cell to the cell of the operator base station.

In some embodiments, the analysis server obtains a plurality of RF signal scan data from a plurality of operator base stations and stores the plurality of RF signal scan data in a database (such as the database 122 of FIG. 1). Additionally or alternatively, in some embodiments, the operator base station captures the RF signal scan data during a period of low activity.

At block 404, the analysis server inputs the RF signal scan data into a machine learning model (such as the machine learning models 230, 330) trained at least in part using historical RF signal scan data indicative of base station operation in an absence of a rogue base station.

In some embodiments, the machine learning model is an anomaly detection model (such as the machine learning model 232 of FIG. 2). In these embodiments, the machine learning model may be (i) trained using historical RF signal scan data generated by the operator base station to generate a baseline for operation of operator base station, and (ii) output an indication of the presence of the rogue base station in response to detecting a deviation between the obtained RF signal scan data and the baseline.

In some embodiments, the machine learning model is a classification model (such as the classification model 234 of FIG. 2). In these embodiments, the machine learning model may be (i) trained using labeled historical RF signal scan data indicative of base station operation in an absence of a rogue base station and labeled historical RF signal scan data indicative of base station operation in a presence of a rogue base station, and (ii) output the indication of the presence of the rogue base station by classifying the RF signal scan data with a label indicative of the presence of the rogue base station.

In some embodiments, the machine learning model is a time series analysis model (such as the time series analysis model 236 of FIG. 2. In these embodiments, the machine learning model may be (i) trained using historical RF signal scan data indicative of base station operation over time in an absence of a rogue base station, (ii) accepts a plurality of RF signal scan data obtained from the operator base station generated across an interval of time, and (iii) output the indication of the presence of the rogue base station in response to detecting an anomalous pattern of operation.

In some embodiments, the machine learning model is an ensemble machine learning model (such as the ensemble model 238 of FIG. 2) that includes two or more of an anomaly detection model, a classification model, and a time series analysis model.

At block 406, the analysis server detects an output (such as the output 240 of FIG. 2) of the machine learning model indicative of a presence of a rogue base station (such as the rogue base station 110 of FIG. 1). In some embodiments, the analysis server validates the presence of the rogue base station by (i) obtaining, from the database, RF signal scan data associated with a neighboring cell; and (ii) inputting the RF signal scan data associated with the neighboring cell into the machine learning model.

At block 408, the analysis server generates an alert indicative of the presence of the rogue base station. In some embodiments, generating the alert includes (i) detecting an output of the machine learning model indicative of the presence of the rogue base station when the RF signal scan data associated with the neighboring cell; (ii) estimating a location of the rogue base station based on a coverage area associated with the cell and the neighboring cell; and (iii) generating the alert such that the alert indicates the estimated location.

In some embodiments, the analysis server may additionally determine a serving cell ID associated with the rogue base station and transmit the serving cell ID to user equipment such that the user equipment refrains from attaching to base stations associated with the serving cell ID.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based upon the application of 35 U.S.C. § 112(f).

Throughout this specification, plural instances may implement components, operations, or structures described as a single instance. For example, in 5G networks, various components may be virtual components distributed across a plurality of servers interconnected to one another and implemented, for example, using a network functions virtualization (NFV) framework. Accordingly, any reference to a 5G network component envisions the logical arrangement of the 5G network component acting as a single function block that is implemented by a plurality of computing devices distributed across a plurality of physical locations of the corresponding network.

Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

This detailed description is to be construed as exemplary only and does not describe every possible embodiment, as describing every possible embodiment would be impractical, if not impossible. One could implement numerous alternate embodiments, using either current technology or technology developed after the filing date of this application. Upon reading this disclosure, those of skill in the art will appreciate still additional alternative structural and functional designs for system and a method for assigning mobile device data to a vehicle through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed:

1. A computer-implemented method comprising:
obtaining, by one or more processors, radio frequency (RF) signal scan data indicative of RF conditions in a cell of an operator base station;
inputting, by the one or more processors, the RF signal scan data into a machine learning model trained at least in part using historical RF signal scan data indicative of base station operation in an absence of a rogue base station;
detecting, by the one or more processors, an output of the machine learning model indicative of a presence of a rogue base station; and
generating, by the one or more processors, an alert indicative of the presence of the rogue base station.

2. The computer-implemented method of claim 1, wherein the RF signal scan data includes indications of random access channel (RACH) failures, standalone dedicated control channel (SDDCH) failures, signal to noise ratio (SINR) values, received signal strength indicator (RSSI) values, or received total wideband power (RTWP) values generated by the operator base station.

3. The computer-implemented method of claim 1, wherein the RF signal scan data includes indications of bit error rate, block error rate, power levels at carrier frequencies, out-of-band power levels, subcarrier spacing, or channel allocation data generated by performing a frequency-domain analysis of signals received at the operator base station.

4. The computer-implemented method of claim 1, wherein the RF signal scan data includes indications of reference signal receive power (RSRP), reference signal received quality (RSRQ), reference signal SINR (RS-SINR), serving cell RF information, neighbor cell RF information, cell ID, or serving cell ID generated by (i) user equipment (UE) served by the operator base station or (ii) a neighboring cell to the cell of the operator base station.

5. The computer-implemented method of claim 1, further comprising:
obtaining, by one or more processors, a plurality of RF signal scan data from a plurality of operator base stations; and
storing, by the one or more processors, the plurality of RF signal scan data in a database.

6. The computer-implemented method of claim 5, further comprising:
validating, by the one or more processors, the presence of the rogue base station by:
obtaining, from the database, RF signal scan data associated with a neighboring cell; and
inputting the RF signal scan data associated with the neighboring cell into the machine learning model.

7. The computer-implemented method of claim 6, wherein generating the alert comprises:
detecting, by the one or more processors, an output of the machine learning model indicative of the presence of the rogue base station when the RF signal scan data associated with the neighboring cell;
estimating, by the one or more processors, a location of the rogue base station based on a coverage area associated with the cell and the neighboring cell; and
generating, by the one or more processors, the alert such that the alert indicates the estimated location.

8. The computer-implemented method of claim 1, wherein:
the machine learning model is an anomaly detection model; and
the machine learning model is (i) trained using historical RF signal scan data generated by the operator base station to generate a baseline for operation of operator base station, and (ii) output the indication of the presence of the rogue base station in response to detecting a deviation between the obtained RF signal scan data and the baseline.

9. The computer-implemented method of claim 1, wherein:
the machine learning model is a classification model; and
the machine learning model is (i) trained using labeled historical RF signal scan data indicative of base station operation in an absence of a rogue base station and labeled historical RF signal scan data indicative of base station operation in a presence of a rogue base station, and (ii) output the indication of the presence of the rogue base station by classifying the RF signal scan data with a label indicative of the presence of the rogue base station.

10. The computer-implemented method of claim 1, wherein:
the machine learning model is a time series analysis model; and
the machine learning model is (i) trained using historical RF signal scan data indicative of base station operation over time in an absence of a rogue base station, (ii) accepts a plurality of RF signal scan data obtained from the operator base station generated across an interval of time, and (iii) output the indication of the presence of the rogue base station in response to detecting an anomalous pattern of operation.

11. The computer-implemented method of claim 1, wherein:
the machine learning model is an ensemble machine learning model that includes two or more of an anomaly detection model, a classification model, and a time series analysis model.

12. The computer-implemented method of claim 1, wherein the operator base station captures the RF signal scan data during a period of low activity.

13. The computer-implemented method of claim 1, further comprising:
determining, by the one or more processors, a serving cell ID associated with the rogue base station; and
transmitting, by the one or more processors, the serving cell ID to user equipment such that the user equipment refrains from attaching to base stations associated with the serving cell ID.

14. A system comprising:
one or more transceivers communicatively coupled to an operator base station;
one or more processors; and
one or more non-transitory memories storing processor-executable instructions that, when executed by the one or more processors, cause the system to:
obtain radio frequency (RF) signal scan data indicative of RF conditions in a cell of an operator base station;
input the RF signal scan data into a machine learning model trained at least in part using historical RF signal scan data indicative of base station operation in an absence of a rogue base station;
detect an output of the machine learning model indicative of a presence of a rogue base station; and
generate an alert indicative of the presence of the rogue base station.

15. The system of claim 14, wherein:
the machine learning model is an anomaly detection model; and
the machine learning model is (i) trained using historical RF signal scan data generated by the operator base station to generate a baseline for operation of operator base station, and (ii) output the indication of the presence of the rogue base station in response to detecting a deviation between the obtained RF signal scan data and the baseline.

16. The system of claim 14, wherein:
the machine learning model is a classification model; and
the machine learning model is (i) trained using labeled historical RF signal scan data indicative of base station operation in an absence of a rogue base station and labeled historical RF signal scan data indicative of base station operation in a presence of a rogue base station, and (ii) output the indication of the presence of the rogue base station by classifying the RF signal scan data with a label indicative of the presence of the rogue base station.

17. The system of claim 14, wherein:
the machine learning model is a time series analysis model; and
the machine learning model is (i) trained using historical RF signal scan data indicative of base station operation over time in an absence of a rogue base station, (ii) accepts a plurality of RF signal scan data obtained from the operator base station generated across an interval of time, and (iii) output the indication of the presence of the rogue base station in response to detecting an anomalous pattern of operation.

18. The system of claim 14, wherein:
the machine learning model is an ensemble machine learning model that includes two or more of an anomaly detection model, a classification model, and a time series analysis model.

19. The system of claim 14, wherein the instructions, when executed, cause the system to:
validate the presence of the rogue base station by:
obtaining, from a database, RF signal scan data associated with a neighboring cell; and
inputting the RF signal scan data associated with the neighboring cell into the machine learning model.

20. A non-transitory storage medium storing computer-executable instructions that, when executed by one or more processors, cause the one or more processors to:
obtain radio frequency (RF) signal scan data indicative of RF conditions in a cell of an operator base station;
input the RF signal scan data into a machine learning model trained at least in part using historical RF signal scan data indicative of base station operation in an absence of a rogue base station;
detect an output of the machine learning model indicative of a presence of a rogue base station; and
generate an alert indicative of the presence of the rogue base station.
